(19) United States
(12) Patent Application Publication
(10) Pub. No.: US 2025/0131305 A1
(43) Pub. Date: Apr. 24, 2025

(54) BRINGING QUANTUM COMPUTE CAPABILITIES TO CLASSICAL COMPUTING CHIPSET

(71) Applicant: QUALCOMM Incorporated, San Diego, CA (US)

(72) Inventors: Ahmed KHAN, Hyderabad (IN); Sharad GANG, Hyderabad (IN)

(21) Appl. No.: 18/491,704

(22) Filed: Oct. 20, 2023

(51) Int. Cl. G06F 9/48; G06N 10/60; G06N 10/80

(52) U.S. Cl. CPC G06N 10/40

(57) ABSTRACT

A quantum computing apparatus has a classical processing unit. The quantum computing apparatus also has a quantum processing unit coupled to the classical processing unit and to a remote quantum computing system to enable execution of processes on the remote quantum computing system. A processor-implemented method includes receiving a query from a classical processing unit via a central processing unit (CPU) interface. The method also includes selecting a task for execution by a remote quantum computing system in response to receiving the query from the classical processing unit.

### BACKGROUND

### Field

Aspects of the present disclosure relate to computing devices, and more specifically to providing quantum compute capabilities to a classical computing chipset.

### Background

Mobile or portable computing devices include mobile phones, laptop, palmtop and tablet computers, portable digital assistants (PDAs), portable game consoles, and other portable electronic devices. Mobile computing devices are comprised of many electrical components that may include system-on-a-chip (SoC) devices, graphics processing unit (GPU) devices, neural processing unit (NPU) devices, digital signal processors (DSPs), and modems, among others. These components perform classical computing operations and may be included in one or more classical computing chipsets.

Quantum computing is a new type of computing that is based on quantum mechanics. Quantum computing is able to solve certain types of problems more efficiently than classical computing. Specialized hardware, which is very expensive, is employed to perform quantum computing. Due to the great expense of quantum computers, for the foreseeable future, quantum computers will continue to reside on the cloud, rather than on local devices. It would be desirable to leverage quantum computing capabilities while retaining the benefits of classical computing on local devices, such as mobile devices.

### SUMMARY

Aspects of the present disclosure are directed to a quantum computing apparatus. The quantum computing apparatus has a classical processing unit. The quantum computing apparatus also has a quantum processing unit coupled to the classical processing unit and to a remote quantum computing system to enable execution of processes on the remote quantum computing system.

In other aspects of the present disclosure, a processor-implemented method includes receiving a query from a classical processing unit via a central processing unit (CPU) interface. The method also includes selecting a task for execution by a remote quantum computing system in response to receiving the query from the classical processing unit.

In other aspects of the present disclosure, a non-transitory computer-readable medium with program code recorded thereon is disclosed. The program code is executed by a processor and includes program code to receive a query from a classical processing unit via a central processing unit (CPU) interface. The program code also includes program code to select a task for execution by a remote quantum computing system in response to receiving the query from the classical processing unit.

Other aspects of the present disclosure are directed to a quantum computing apparatus. The quantum computer apparatus has a classical processing unit. The quantum computer apparatus also includes means for executing processes on a remote quantum computing system, the executing means coupled to the classical processing unit and to the remote quantum computing system.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a quantum processing unit, in accordance with certain aspects of the present disclosure.

FIG. 2 is a diagram illustrating a single qubit representation and a two qubit representation.

FIGS. 3 and 4 illustrate simple quantum circuits.

FIG. 5 illustrates a complex quantum circuit.

FIG. 6 illustrates a generic quantum circuit.

FIG. 7 illustrates sample code from a software development kit (SDK) representing the quantum circuit of FIG. 6.

FIG. 8 is a table illustrating examples of quantum computing algorithms.

FIG. 9 is a block diagram illustrating a high level architecture of a local classical chipset and a remote quantum computer, in accordance with various aspects of the present disclosure.

FIG. 10 is a block diagram illustrating a quantum compute unit (QPU) architecture, in accordance with various aspects of the present disclosure.

FIG. 11 is a block diagram illustrating an algorithm mapper, in accordance with various aspects of the present disclosure.

FIG. 12 is a flow diagram illustrating an example process performed, for example, by a mobile device, in accordance with various aspects of the present disclosure.

FIG. 13 is a block diagram showing an exemplary wireless communications system in which a configuration of the present disclosure may be advantageously employed.

FIG. 14 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR.” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Mobile computing devices are comprised of many electrical components that may include system-on-a-chip (SoC) devices, graphics processing unit (GPU) devices, neural processing unit (NPU) devices, digital signal processors (DSPs), and modems, among others. These components perform classical computing operations and may be included in one or more classical computing chipsets.

Quantum computing is a new type of computing that is based on quantum mechanics. Quantum computing is able to solve certain types of problems more efficiently than classical computing. Specialized hardware, which is very expensive, is employed to perform quantum computing. It would be desirable to leverage quantum computing capabilities while retaining the benefits of classical computing.

Aspects of the present disclosure provide mobile device applications with access to quantum compute algorithms and quantum computers. These aspects map core functionality to quantum algorithms on the cloud. Further aspects introduce a software development kit (SDK) for developers to experiment with this emerging technology. A dedicated core may be provided on local devices, such as mobile devices, to access quantum compute capabilities. The dedicated core may be provided in between a classical core on the local device and a quantum compute core on a remote quantum compute device. The dedicated core maps some core algorithms to quantum computers.

Particular aspects of the subject matter described in this disclosure can be implemented to realize one or more of the following potential advantages. In some examples, the described apparatus, such as a quantum processing unit (QPU) coupled to a classical processing unit enables more efficient computation for certain types of compute tasks. The apparatus provides mobile devices with access to quantum compute algorithms and quantum computers.

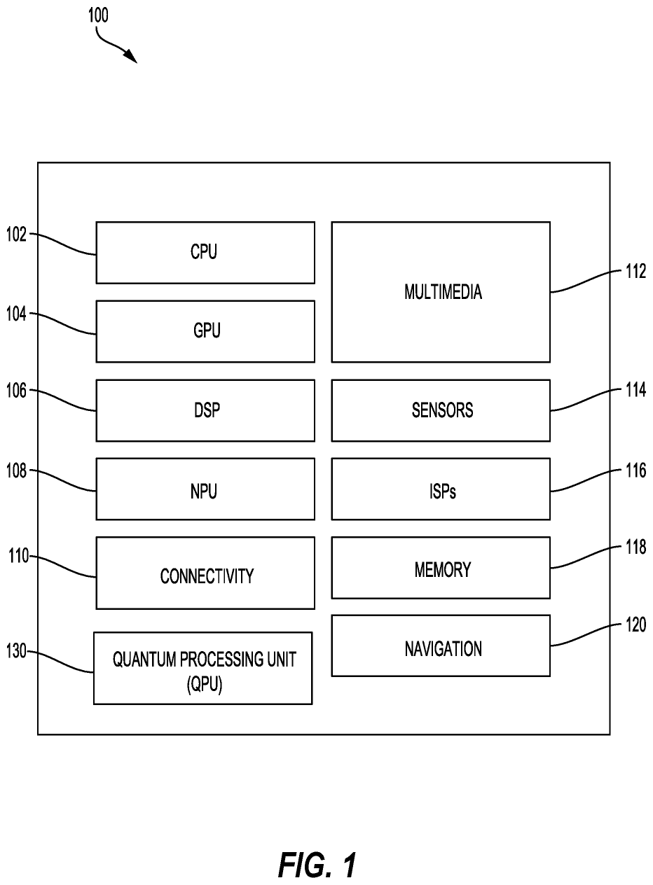

FIG. 1 illustrates an example implementation of a host system-on-a-chip (SoC) 100, which includes a quantum processing unit (QPU) 130, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

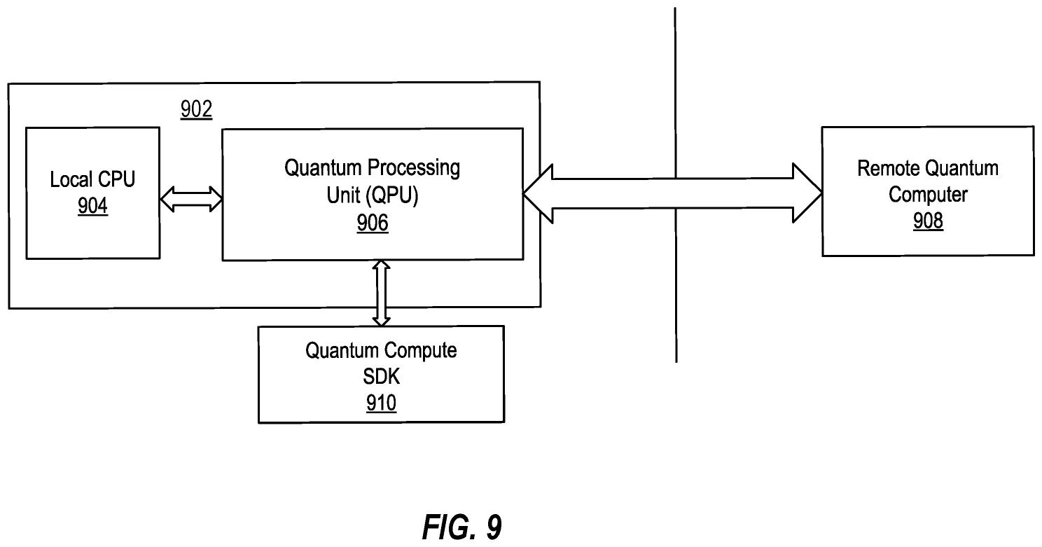

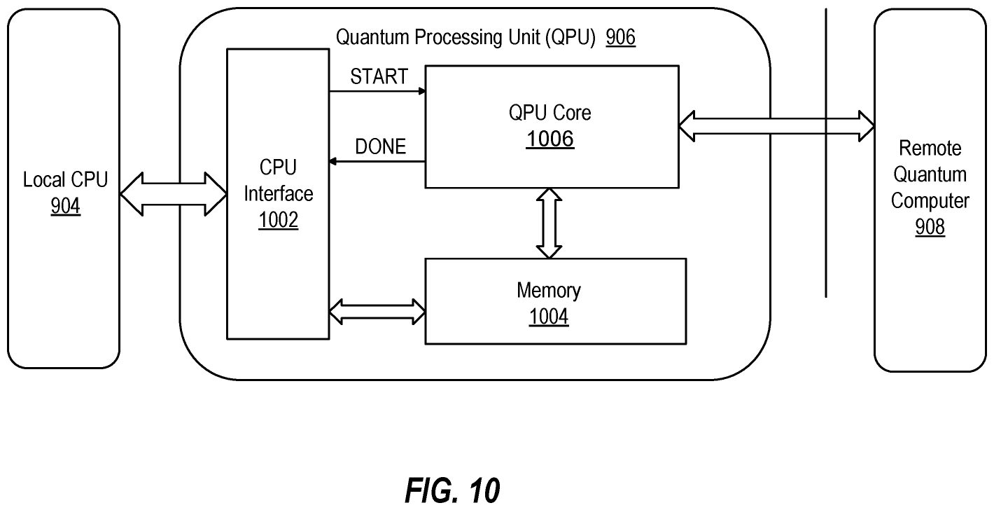

As noted above, it would be desirable to leverage quantum computing capabilities while retaining the benefits of classical computing. Aspects of the present disclosure provide mobile devices with access to quantum compute algorithms and quantum computers. According to aspects of the present disclosure, a mobile device includes a quantum processing unit (QPU). The QPU may include means for executing, means for mapping, means for encoding, means for receiving, means for selecting, means for processing, means for defining, means for driving, means for optimizing. In one configuration, the executing means, the mapping means, the encoding means, the receiving means, the selecting means, the processing means, the defining means, the driving means, and the optimizing means may be the QPU core 1006 and/or the QPU 906, as shown in FIGS. 9 and 10. In other aspects, the aforementioned means may be any structure or any material configured to perform the functions recited by the aforementioned means.

Quantum computing is a new type of computing that is based on quantum mechanics. Quantum computing is able to solve certain types of problems more efficiently than classical computing. Specialized hardware, which is very expensive, is employed to perform quantum computing. Non-limiting exemplary technologies for implementing quantum computers include super cooled (e.g., <15 mK (millikelvin) of absolute zero) Josephson junctions with a microwave photon interface, and quantum annealing. It would be desirable to have access to the quantum computing capabilities of the specialized hardware from classical chipsets.

In classical computing, bits can have states of ‘0’ or ‘1’. In quantum computing, quantum bits or qubits are represented with the bracketed notation |0> and |1>. Qubits can exist in a superposition of 0 and 1 represented as α|0>+β|1> where α and β are complex numbers indicating a probability of a value of 0 or 1, respectively, and |α²|+|β²|=1.

Similar to classical gates operating on bits, in quantum computing, quantum gates are unitary transformations on qubits. Because qubits can exist in a superposition of |0> and |1> states, computation will occur on all the states in superposition simultaneously. The solution or result is extracted via constructive interference of a solution state followed by a wavefunction collapsing measurement.

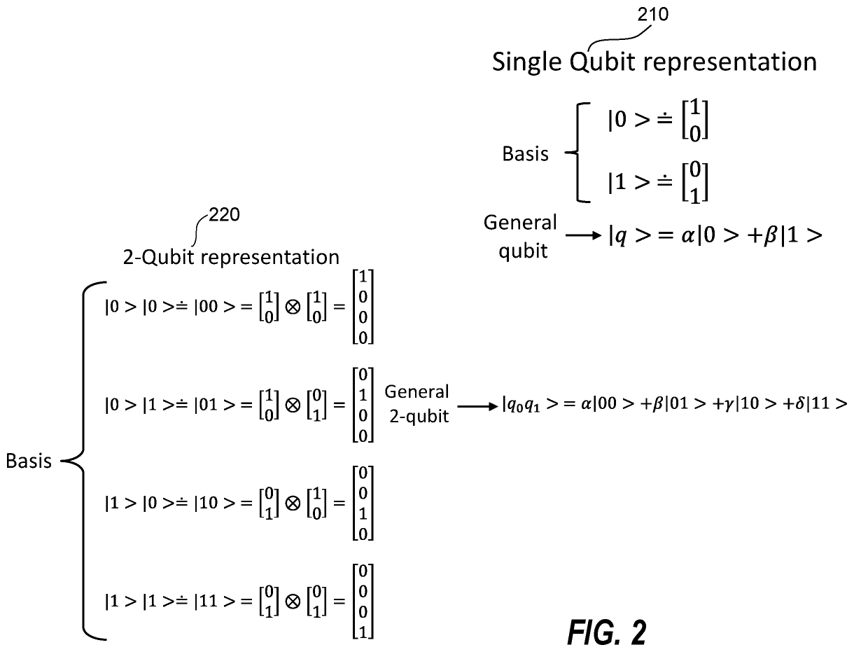

FIG. 2 is a diagram illustrating a single qubit representation and a two qubit representation. As seen in FIG. 2, a single qubit representation 210 includes a basis that can be represented in matrix form with column vectors [1,0] and [0,1]. A general qubit represented as |q> is a superposition of α|0>+β|1>. A two qubit representation 220 is shown in a different form than the single qubit representation 210. As shown in the two qubit representation 220, the two qubits are based on an outer product of two column vectors. For example, the two qubits |0> |0> or |00> are equal to the outer product of the column vectors [1,0] resulting in the basis state represented as the column vector of [1,0,0,0]. Other examples for the qubits |01>, |10>, and |11> are shown in the representation 220, where each basis state is orthogonal to each other basis state. A general two qubit is also shown where α, β, γ, and δ are complex weights. Even more generally, n qubits result in 2ⁿ states.

Examples of quantum gates are seen below:

$$Pauli - X gate : X \vert 0 >= \vert 1 > , X \vert 1 >= \vert 0 > X = [ \begin{matrix}0 & 1 \\ 1 & 0\end{matrix} ]$$

$$Pauli - Y gate : Y \vert 0 >= i \vert 1 > , Y \vert 1 >= - i \vert 0 > Y = [ \begin{matrix}0 & - i \\ i & 0\end{matrix} ]$$

$$Pauli - Z gate : Z \vert 0 >= \vert 0 > , Z \vert 1 >= - \vert 1 > Z = [ \begin{matrix}1 & 0 \\ 0 & - 1\end{matrix} ]$$

$$Hadamard gate : H \vert 0 >= \frac{1}{\sqrt{2}} \{ \vert 0 > + \vert 1 > \} , H \vert 1 > = \frac{1}{\sqrt{2}} \{ \vert 0 > - \vert 1 > \}$$

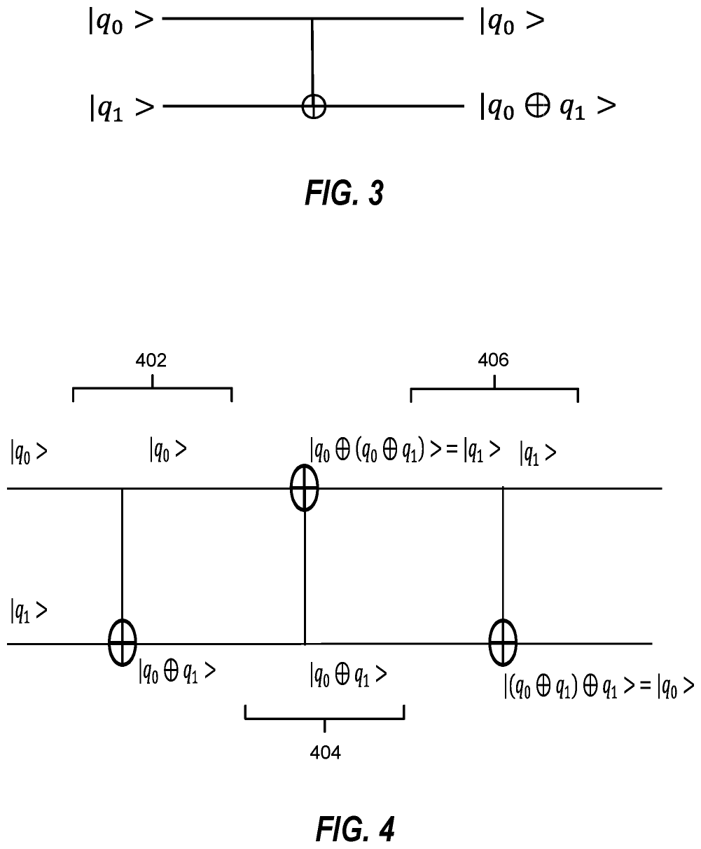

FIGS. 3 and 4 illustrate simple quantum circuits. In the example of FIG. 3, two inputs |q₀> and |q₁> to a controlled NOT (CNOT) gate result in the output as follows:

|00>→|00>

|01>→|01>

|10>→|01>

|11>→|10>

It can be seen that the CNOT gate of FIG. 3 operates similarly to a classical exclusive OR (XOR) gate. In the circuit of FIG. 3, the symbol ⊕ represents the exclusive OR (XOR) operation.

In the example of FIG. 4, two qubit inputs |q₀> and |q₁> are received at a bit swap gate. The bit swap gate includes three CNOT gates 402, 404, 406.

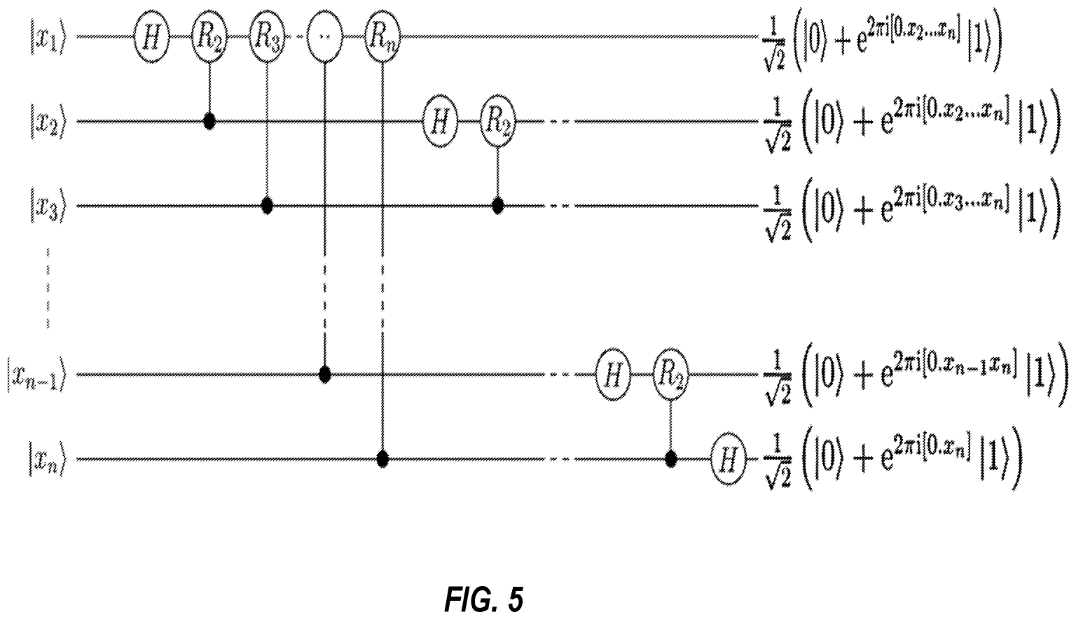

FIG. 5 illustrates a complex quantum circuit. In the example of FIG. 5, a circuit for implementing a quantum Fourier transform is shown. A sequence of n superimposed qubits |x₁> . . . |xₙ> is received as input. Hadamard gates and controlled n rotation gates are represented as \textcircled{H} and ®, respectively. Based on the input, the circuit calculates a Fourier transform of the sequence, equivalent to:

$$\vert j > \to \frac{1}{\sqrt{n}} {\sum }_{k} {e}^{\frac{2 π ijk}{n}} \vert k > ,$$

where i is the square root of −1, j is a binary sequence, k is the index counter, and n is the number of values in the input sequence.

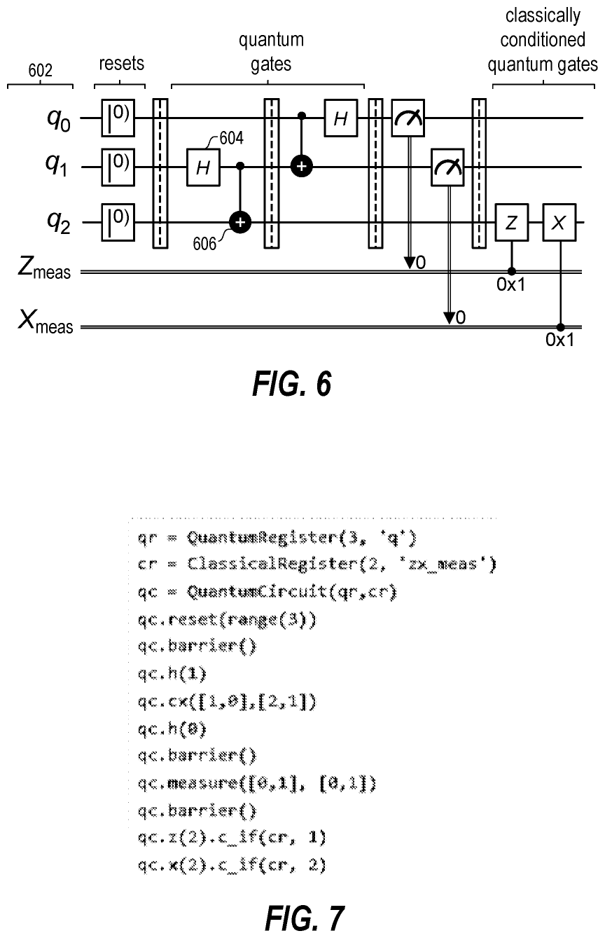

FIG. 6 illustrates a generic quantum circuit. In the example of FIG. 6, a set of input qubits 602 are received and prepared in a basis state (e.g., ‘resets’). The values are then processed by quantum gates (e.g., Hadamard gates 604 and CNOT gates 606). Wavefunction collapsing measurements are performed after the computation by the quantum gates. Classically conditioned quantum gates may then operate on the measurement results.

FIG. 7 illustrates sample code from a software development kit (SDK) representing the quantum circuit of FIG. 6. Several different languages exist to describe quantum circuits. Qiskit is an IBM SDK that provides a Python style programming interface for quantum circuit instantiation. Qiskit interfaces with IBM quantum computers, which execute the Qiskit code and return results. The code illustrated in FIG. 7 represents the circuit of FIG. 6 in Qiskit code. QASM (Quantum Assembly Language) is another example of a programming language for quantum computing. It is noted that the present disclosure is not limited to any particular framework for representing quantum circuits.

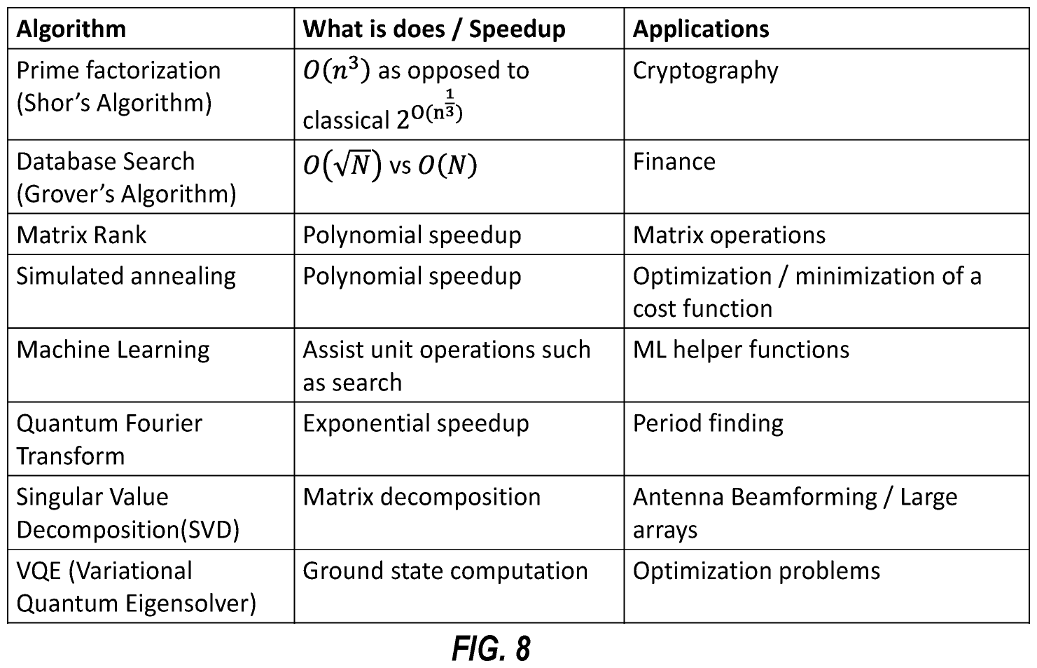

FIG. 8 is a table illustrating examples of quantum computing algorithms. The table states that a prime factorization algorithm with cryptology applications has an efficiency of O(n³) instead of 2^{O(n1/3)}, where O is the big O notation representing an algorithm's efficiency. Other types of quantum computing algorithms are also described in the table of FIG. 8.

Quantum computers require extremely low temperatures to operate because qubit fidelity is directly related to thermal noise. Hence, quantum computers operate at very close to absolute zero. Due to the great expense of quantum computers, for the foreseeable future, quantum computers will continue to reside on the cloud, rather than on local devices such as mobile devices. Although some companies may have their own machines (either developed in-house or bought from vendors), these companies are the exception. When quantum computation is offered as a cloud service, compute resources may be provided on a time-shared/paid basis to customers over the web.

The number of quantum algorithms will continue to increase over time. Only a few quantum algorithms were known in the 1990s, whereas many more are currently known, and more algorithms will continue to be discovered. As newer algorithms are discovered, “quantum compute” thinking will percolate further to developers, and wider and more general applications will emerge. Consequently, applications that take advantage of quantum algorithms will also grow.

Aspects of the present disclosure provide access for applications on mobile devices to quantum compute algorithms and quantum computers. These aspects map core functionality of the mobile device to quantum algorithms on the cloud. Further aspects introduce an SDK for developers to experiment with this emerging technology. The SDK will nurture “Quantum Compute” thinking in the developer community, and will spur development and discovery of new quantum algorithms.

A dedicated core may be provided on local devices, e.g., mobile devices, to access quantum compute capabilities. The dedicated core may be provided in between a classical core on the local device and a quantum compute core on a remote quantum compute device. The dedicated core maps core algorithms to quantum computers.

Quantum computers available on the cloud have a variety of different capabilities. These different capabilities may include a different numbers of qubits (e.g., 128 qubits of 256 qubits) and qubit fidelity that varies between the quantum machines. Aspects of the present disclosure are directed to selecting the right machine configuration for a given problem. For example, a machine with 256 qubits may be more than needed for a simple quantum task, and thus a 128 qubit machine may be selected.

FIG. 9 is a block diagram illustrating a high level architecture of a local classical chipset and a remote quantum computer, in accordance with various aspects of the present disclosure. In the example of FIG. 9, a local device 902, for example a mobile device, includes a local central processing unit (CPU) 904 and a quantum processing unit (QPU) 906. The QPU 906 communicates with a remote quantum computer 908 and also interfaces with a quantum compute software development kit (SDK) 910. The local CPU 904 may be a general purpose CPU that performs classical processing, for example, the classical portions needed by the remote quantum computer 908 (e.g., input/output setup) or the classical portions of the remote quantum computer 908 is unable to process efficiently. The design shown in FIG. 9 is generic and allows for a myriad of roles for the QPU 906. In the example of FIG. 9, the QPU 906 is directly accessible from an SDK framework (e.g., quantum compute SDK 910) for developers to experiment with and develop quantum algorithms.

FIG. 10 is a block diagram illustrating a quantum compute unit (QPU) architecture, in accordance with various aspects of the present disclosure. In the example of FIG. 10, the QPU 906 includes a CPU interface 1002 that communicates with the local CPU 904. In some implementations, the CPU interface 1002 is a memory interface that passes arguments. The local CPU 904 determines quantum compute appropriate workloads, converts them to tasks, and queues them in QPU memory 1004 via the CPU interface 1002.

When the CPU interface 1002 receives the arguments, the CPU interface 1002 may transmit a START signal to a QPU core 1006. The QPU core 1006 may perform the “classical part” of the quantum algorithm, including processing for algorithm mapping, classical oracle functionality, and classical compute assistance when some portions of the task are executed classically and some portions are executed by the remote quantum computer 908. The QPU core 1006 interfaces with the remote quantum computer 908 and transmits a DONE signal to the CPU interface 1002 when the computation by the remote quantum computer 908 is completed.

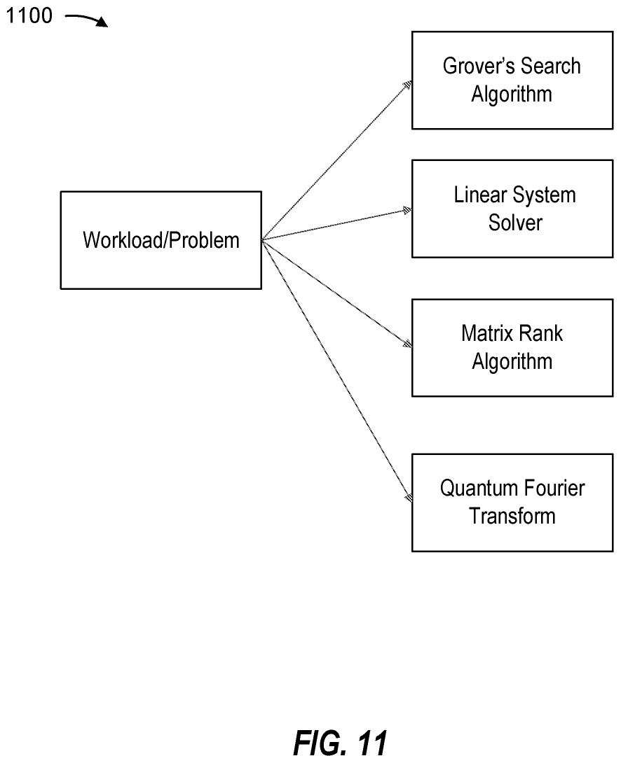

FIG. 11 is a block diagram illustrating an algorithm mapper 1100, in accordance with various aspects of the present disclosure. The algorithm mapper is one of the functions of the QPU core 1006. The role of the algorithm mapper 1100 is to determine an appropriate quantum algorithm to execute on the remote quantum computer 908 based on the task received from the local CPU 904. The algorithm mapper 1100 prepares and transmits arguments to the remote quantum computer 908. As part of the determination, the algorithm mapper 1100 evaluates a communication vs. computation tradeoff. The evaluation weighs the input/output (I/O) latency cost of communicating with the remote quantum computer 908. Workloads that benefit from quantum computing are those that incur high computation costs with a relatively low volume of argument passing. In the example of FIG. 11, the algorithm mapper 1100 analyzes the workload/problem and selects a quantum algorithm. In the example of FIG. 11, the candidate quantum algorithms include a Grover's search algorithm, a linear system solver, a matrix rank algorithm, and a quantum Fourier transform.

A classical oracle is another entity of the QPU core 1006. The role of an oracle in computation is to answer a query, with a binary reply (yes or no). This may be computationally less intensive than finding an input query for which the binary reply is a yes. This is analogous to evaluating a binary valued function f at given point x to yield f(x), as opposed to finding x for a given f(x), the latter being a more intensive computation than the former. The classical oracle may evaluate a function at a given input point. For example, with a Grover's search algorithm, the classical oracle assists in finding an index that points to one (1). As input for a Grover's search algorithm, assume a function f: {0, 1, . . . . N−1}->{0, 1}. The domain represents indices to a database and f(x)=1 if and only if the data that points to x satisfies the search criterion. It is assumed that only one index satisfies f(x)=1. The classical oracle assists the Grover's search algorithm to find the index.

In some aspects, the QPU core 1006 maps a classical oracle to a quantum oracle. That is, for implementation on the remote quantum computer 908, the classical oracle will need to be converted to a quantum oracle. The following steps may be implemented to achieve the mapping. First, the QPU core 1006 implements a classical oracle using classical gates (not AND (NAND), not OR (NOR), etc.). Then, the QPU core 1006 converts classical gates to reversible classical gates, where some garbage bits are introduced. Next, the QPU core 1006 converts the classical gates to quantum gates (e.g., universal quantum gates, Toffoli/Fredkin gates, etc.). Finally, the QPU core 1006 erases garbage gates using a controlled NOT (CNOT) gate and forwards the quantum oracle to the remote quantum computer 908.

Another role of the QPU core 1006 is encoding inputs and decoding outputs for the remote quantum computer 908. A quantum computation may involve preparing the qubits in a specific state of superposition. The weights of the superposition represent the input of the computation. The QPU core 1006 performs the weight computation. An example is described with respect to a Harrow-Hassidim-Lloyd (HHL) algorithm for solving large linear systems of equations. For a sparse N×N linear system with condition number K, the runtime is O(K² log N) for quantum computing versus O(NK) for a classical computer. To solve for x in the equation:

Ax=b,

where the matrix A and the value b are known, the classical encode step performed by the QPU core 1006 is: b→|b>=Σᵢbᵢ|i>.

The solution step performed on the quantum computer applies the Hamiltonian e^{At} to |b> to obtain |x>, where t represents time. The Hamiltonian evolution (e^{At}) can be computed efficiently by quantum computers.

Another role of the QPU core 1006 is a classical optimizer in variational quantum Eigen-solver (VQE) problems. A VQE is a hybrid classical-quantum algorithm paradigm for solving a general class of optimization problems, such as minimizing a cost function. Some optimization problems (especially molecular structure inference) can be posed as a ground state estimation problem. The goal is to obtain the least energy for a Hamiltonian H with a wavefunction parameterized over θ according to the cost function E=<ψ(θ)|H|ψ(θ)>, where ψ(θ) is a state.

The computation steps include mapping the Hamiltonian H to a qubit Hamiltonian (e.g., a string of Pauli operators), and implementing the Hamiltonian H as a quantum circuit. The next steps include preparing a trial state ψ(θ₀), and using a quantum circuit to evaluate <ψ(θ₀)|H|ψ(θ₀)>. A classical step is performed next and involves refining θ: θₖ₊₁=f(θₖ), for example, with gradient descent. The quantum circuit evaluation and classical steps then repeat until convergence occurs.

Yet another role of the QPU core 1006 is to perform a classical compute assist. For example, a loss function evaluation may be desired for a singular value decomposition (SVD). An SVD operation has applications in beamforming weight computation for antenna arrays, for example. For an SVD calculation, a classical CPU (e.g., the QPU core 1006) performs the classical computation and the quantum computer (e.g., the remote quantum computer 908) performs the quantum calculation.

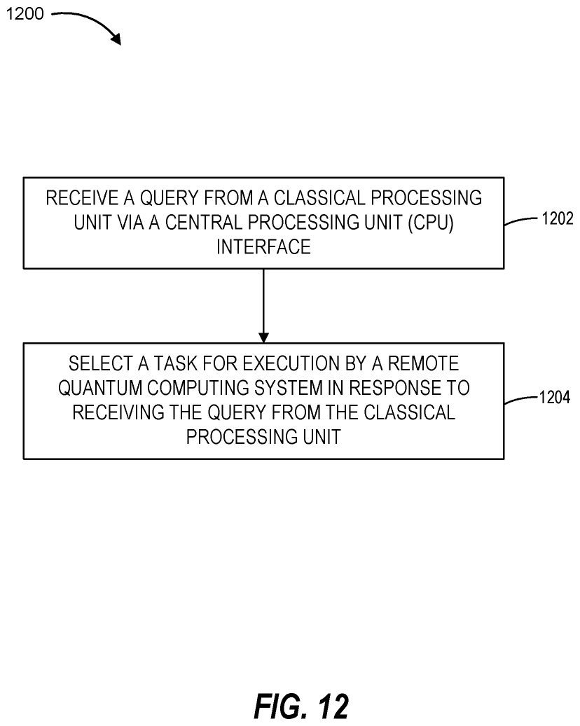

FIG. 12 is a flow diagram illustrating an example process 1200 performed, for example, by a mobile device, in accordance with various aspects of the present disclosure. The example process 1200 is an example of performing quantum computing from a mobile device.

As shown in FIG. 12, in some aspects, the process 1200 may include receiving a query from a classical processing unit via a central processing unit (CPU) interface (block 1202). In some aspects, the process may encode the query from the classical processing unit by preparing a superposition state of qubits, the superposition state comprising weights calculated by a quantum processing unit.

In some aspects, the process 1200 may include selecting a task for execution by a remote quantum computing system in response to receiving the query from the classical processing unit (block 1204). For example, the task for execution may be selected by the remote quantum computing system based at least in part on a latency associated with communicating with the remote quantum computing system, and a level of computation performed by the remote quantum computing system to complete the task. In some aspects, the query may request beamforming weights and the task for execution may be singular value decomposition. In other aspects, process includes selecting the remote quantum computing system from a plurality of remote quantum computing systems based at least in part on a fidelity and a number of qubits of the remote quantum computing system, and the query received from the classical processing unit.

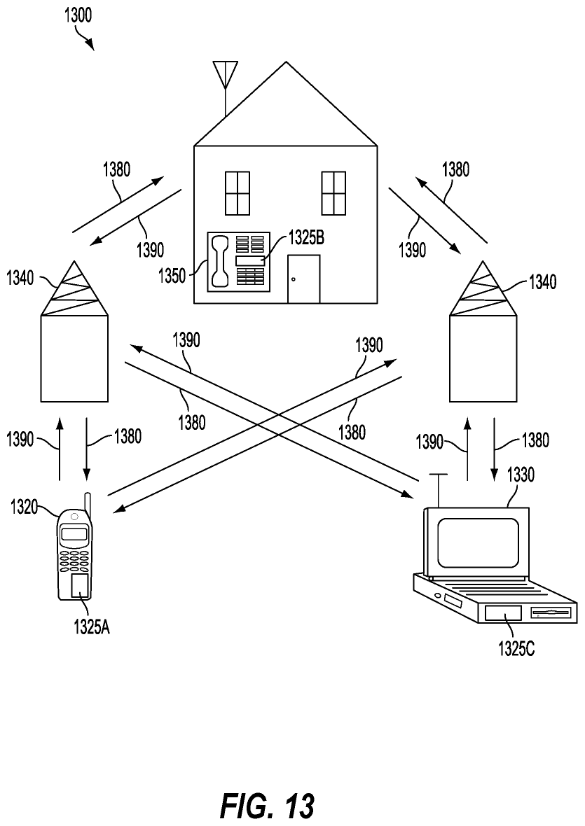

FIG. 13 is a block diagram showing an exemplary wireless communications system 1300, in which an aspect of the present disclosure may be advantageously employed. For purposes of illustration, FIG. 13 shows three remote units 1320, 1330, and 1350, and two base stations 1340. It will be recognized that wireless communications systems may have many more remote units and base stations. Remote units 1320, 1330, and 1350 include integrated circuit (IC) devices 1325A, 1325B, and 1325C that include the disclosed QPU. It will be recognized that other devices may also include the disclosed QPU, such as the base stations, switching devices, and network equipment. FIG. 13 shows forward link signals 1380 from the base stations 1340 to the remote units 1320, 1330, and 1350, and reverse link signals 1390 from the remote units 1320, 1330, and 1350 to the base stations 1340.

In FIG. 13, remote unit 1320 is shown as a mobile telephone, remote unit 1330 is shown as a portable computer, and remote unit 1350 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 13 illustrates remote units according to the aspects of the present disclosure, the disclosure is not limited to these exemplary illustrated units. Aspects of the present disclosure may be suitably employed in many devices, which include the disclosed QPU.

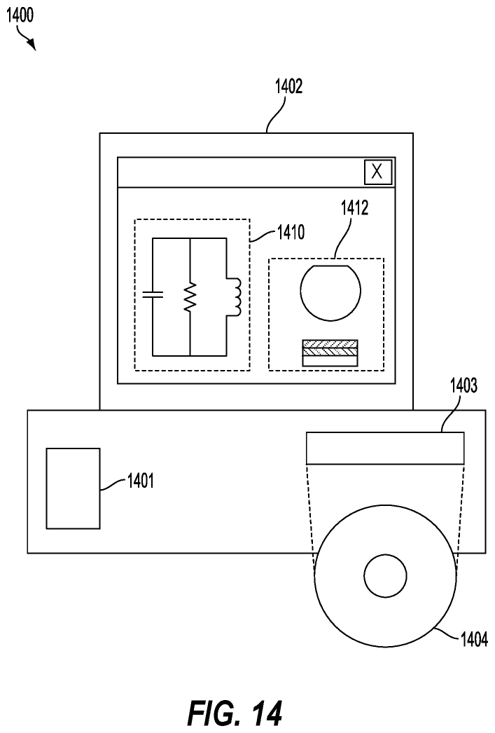

FIG. 14 is a block diagram illustrating a design workstation 1400 used for circuit, layout, and logic design of a semiconductor component, such as the QPU above. The design workstation 1400 includes a hard disk 1401 containing operating system software, support files, and design software such as Cadence or OrCAD. The design workstation 1400 also includes a display 1402 to facilitate design of a circuit 1410 or a semiconductor component 1412, such as the QPU. A storage medium 1404 is provided for tangibly storing the design of the circuit 1410 or the semiconductor component 1412 (e.g., the PLD). The design of the circuit 1410 or the semiconductor component 1412 may be stored on the storage medium 1404 in a file format such as GDSII or GERBER. The storage medium 1404 may be a CD-ROM, DVD, hard disk, flash memory, or other appropriate device. Furthermore, the design workstation 1400 includes a drive apparatus 1403 for accepting input from or writing output to the storage medium 1404.

Data recorded on the storage medium 1404 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1404 facilitates the design of the circuit 1410 or the semiconductor component 1412 by decreasing the number of processes for designing semiconductor wafers.

### Example Aspects

Aspect 1: A quantum computing apparatus, comprising: a classical processing unit; and a quantum processing unit coupled to the classical processing unit and to a remote quantum computing system to enable execution of processes on the remote quantum computing system.

Aspect 2: The quantum computing apparatus of Aspect 1, in which the quantum processing unit comprises: a central processing unit (CPU) interface coupled to the classical processing unit; at least one memory coupled to the CPU interface; and a quantum processing unit core coupled to the CPU interface, the at least one memory, and the remote quantum computing system.

Aspect 3: The quantum computing apparatus of Aspect 1 or 2, in which the quantum processing unit core is configured to select a task for execution by the remote quantum computing system in response to receiving a query from the classical processing unit via the CPU interface.

Aspect 4: The quantum computing apparatus of any of the preceding Aspects, in which the quantum processing unit core is configured to select the task for execution by the remote quantum computing system based at least in part on a latency associated with communicating with the remote quantum computing system, and a level of computation performed by the remote quantum computing system to complete the task.

Aspect 5: The quantum computing apparatus of any of the preceding Aspects, in which the query from the classical processing unit comprises requesting beamforming weights and the task for execution by the remote quantum computing system comprises singular value decomposition.

Aspect 6: The quantum computing apparatus of any of the preceding Aspects, in which the quantum processing unit is configured to encode a query from the classical processing unit by preparing a superposition state of qubits, the superposition state comprising weights calculated by the quantum processing unit.

Aspect 7: The quantum computing apparatus of any of the preceding Aspects, in which the quantum processing unit is configured to receive, from the remote quantum computing system, at least one of Fourier transform results or linear system equation results based on the superposition state.

Aspect 8: The quantum computing apparatus of any of the preceding Aspects, in which the quantum processing unit is configured to map a classical oracle to a quantum oracle by converting classical gates to reversible classical gates; converting the reversible classical gates to quantum gates; and erasing garbage gates using a controlled NOT (CNOT) gate.

Aspect 9: The quantum computing apparatus of any of the preceding Aspects, in which the quantum processing unit is configured to select the remote quantum computing system from a plurality of remote quantum computing systems based at least in part on a fidelity and a number of qubits of the remote quantum computing system and a query received from the classical processing unit.

Aspect 10: The quantum computing apparatus of any of the preceding Aspects, in which the quantum processing unit is configured: to process any specific argument passing specifications for the selected remote quantum computing system, the specifications including application programming interfaces (APIs) exported by the remote quantum computing system for interface with the remote quantum computing system; to define the execution of the processes on the remote quantum computing system; and to drive the execution of the processes on the remote quantum computing system.

Aspect 11: The quantum computing apparatus of any of the preceding Aspects, in which the quantum processing unit is accessible from a software development kit (SDK).

Aspect 12: The quantum computing apparatus of any of the preceding Aspects, in which the quantum processing unit is configured: to optimize a cost function, the cost function optimization converted to a VQE (Variational Quantum Eigen-solver) optimization; to receive an evaluation of the cost function from the remote quantum computing system; to execute a classical step of the VQE, including a gradient descent process based on the evaluation; and the executing the classical step and the receiving the evaluation iteratively occurring in order to converge to a solution of the VQE optimization.

Aspect 13: A processor-implemented method, comprising: receiving a query from a classical processing unit via a central processing unit (CPU) interface; and selecting a task for execution by a remote quantum computing system in response to receiving the query from the classical processing unit.

Aspect 14: The processor-implemented method of Aspect 13, further comprising selecting the task for execution by the remote quantum computing system based at least in part on a latency associated with communicating with the remote quantum computing system, and a level of computation performed by the remote quantum computing system to complete the task.

Aspect 15: The processor-implemented method of Aspect 13 or 14, in which the query from the classical processing unit comprises requesting beamforming weights and the task for execution by the remote quantum computing system comprises singular value decomposition.

Aspect 16: The processor-implemented method of any of the Aspects 13-15, further comprising encoding the query from the classical processing unit by preparing a superposition state of qubits, the superposition state comprising weights calculated by a quantum processing unit.

Aspect 17: The processor-implemented method of any of the Aspects 13-16, further comprising receiving from the remote quantum computing system at least one of Fourier transform results or linear system equation results based on the superposition state.

Aspect 18: The processor-implemented method of any of the Aspects 13-17, further comprising mapping a classical oracle to a quantum oracle by converting classical gates to reversible classical gates; converting the reversible classical gates to quantum gates; and erasing garbage gates using a controlled NOT (CNOT) gate.

Aspect 19: The processor-implemented method of any of the Aspects 13-18, further comprising selecting the remote quantum computing system from a plurality of remote quantum computing systems based at least in part on a fidelity and a number of qubits of the remote quantum computing system, and the query received from the classical processing unit.

Aspect 20: The processor-implemented method of any of the Aspects 13-19, further comprising: processing any specific argument passing specifications for the selected remote quantum computing system, the specifications including application programming interfaces (APIs) exported by the remote quantum computing system for interface with the remote quantum computing system; defining execution of processes on the remote quantum computing system; and driving the execution of the processes on the remote quantum computing system.

Aspect 21: The processor-implemented method of any of the Aspects 13-20, further comprising: optimizing a cost function, the cost function optimization converted to a VQE (Variational Quantum Eigen-solver) optimization; receiving an evaluation of the cost function from the remote quantum computing system; executing a classical step of the VQE, including a gradient descent process based on the evaluation; and iteratively repeating the executing the classical step and the receiving the evaluation until convergence to a solution of the VQE optimization.

Aspect 22: A non-transitory computer-readable medium having program code recorded thereon, the program code executed by a processor and comprising: program code to receive a query from a classical processing unit via a central processing unit (CPU) interface; and program code to select a task for execution by a remote quantum computing system in response to receiving the query from the classical processing unit.

Aspect 23: The non-transitory computer-readable medium of Aspect 22, in which the program code comprises program code to select the task for execution by the remote quantum computing system based at least in part on a latency associated with communicating with the remote quantum computing system, and a level of computation performed by the remote quantum computing system to complete the task.

Aspect 24: The non-transitory computer-readable medium of Aspect 22 or 23, in which the query from the classical processing unit comprises requesting beamforming weights and the task for execution by the remote quantum computing system comprises singular value decomposition.

Aspect 25: The non-transitory computer-readable medium of any of the Aspects 22-24, in which the program code comprises program code to encode the query from the classical processing unit by preparing a superposition state of qubits, the superposition state comprising weights calculated by a quantum processing unit.

Aspect 26: The non-transitory computer-readable medium of any of the Aspects 22-25, in which the program code comprises program code to receive from the remote quantum computing system at least one of Fourier transform results or linear system equation results based on the superposition state.

Aspect 27: The non-transitory computer-readable medium of any of the Aspects 22-26, in which the program code comprises program code to map a classical oracle to a quantum oracle by converting classical gates to reversible classical gates; program code to convert the reversible classical gates to quantum gates; and program code to erase garbage gates using a controlled NOT (CNOT) gate.

Aspect 28: The non-transitory computer-readable medium of any of the Aspects 22-27, in which the program code comprises program code to select the remote quantum computing system from a plurality of remote quantum computing systems based at least in part on a fidelity and a number of qubits of the remote quantum computing system, and the query received from the classical processing unit.

Aspect 29: The non-transitory computer-readable medium of any of the Aspects 22-28, in which the program code comprises: program code to process any specific argument passing specifications for the selected remote quantum computing system, the specifications including application programming interfaces (APIs) exported by the remote quantum computing system for interface with the remote quantum computing system; program code to define execution of processes on the remote quantum computing system; and program code to drive the execution of the processes on the remote quantum computing system.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A quantum computing apparatus, comprising:
a classical processing unit; and
a quantum processing unit coupled to the classical processing unit and to a remote quantum computing system to enable execution of processes on the remote quantum computing system.

2. The quantum computing apparatus of claim 1, in which the quantum processing unit comprises:
a central processing unit (CPU) interface coupled to the classical processing unit;
at least one memory coupled to the CPU interface; and
a quantum processing unit core coupled to the CPU interface, the at least one memory, and the remote quantum computing system.

3. The quantum computing apparatus of claim 2, in which the quantum processing unit core is configured to select a task for execution by the remote quantum computing system in response to receiving a query from the classical processing unit via the CPU interface.

4. The quantum computing apparatus of claim 3, in which the quantum processing unit core is configured to select the task for execution by the remote quantum computing system based at least in part on a latency associated with communicating with the remote quantum computing system, and a level of computation performed by the remote quantum computing system to complete the task.

5. The quantum computing apparatus of claim 3, in which the query from the classical processing unit comprises requesting beamforming weights and the task for execution by the remote quantum computing system comprises singular value decomposition.

6. The quantum computing apparatus of claim 1, in which the quantum processing unit is configured to encode a query from the classical processing unit by preparing a superposition state of qubits, the superposition state comprising weights calculated by the quantum processing unit.

7. The quantum computing apparatus of claim 6, in which the quantum processing unit is configured to receive, from the remote quantum computing system, at least one of Fourier transform results or linear system equation results based on the superposition state.

8. The quantum computing apparatus of claim 1, in which the quantum processing unit is configured to map a classical oracle to a quantum oracle by converting classical gates to reversible classical gates; converting the reversible classical gates to quantum gates; and erasing garbage gates using a controlled NOT (CNOT) gate.

9. The quantum computing apparatus of claim 1, in which the quantum processing unit is configured to select the remote quantum computing system from a plurality of remote quantum computing systems based at least in part on a fidelity and a number of qubits of the remote quantum computing system and a query received from the classical processing unit.

10. The quantum computing apparatus of claim 9, in which the quantum processing unit is configured:
to process any specific argument passing specifications for the selected remote quantum computing system, the specifications including application programming interfaces (APIs) exported by the remote quantum computing system for interface with the remote quantum computing system;
to define the execution of processes on the remote quantum computing system; and
to drive the execution of processes on the remote quantum computing system.

11. The quantum computing apparatus of claim 1, in which the quantum processing unit is accessible from a software development kit (SDK).

12. The quantum computing apparatus of claim 1, in which the quantum processing unit is configured:
to optimize a cost function that is converted to a VQE (Variational Quantum Eigen-solver) optimization;
to receive an evaluation of the cost function from the remote quantum computing system;
to execute a classical step of the VQE, including a gradient descent process based on the evaluation; and
the executing the classical step and the receiving the evaluation iteratively occurring in order to converge to a solution of the VQE optimization.

13. A processor-implemented method, comprising:
receiving a query from a classical processing unit via a central processing unit (CPU) interface; and
selecting a task for execution by a remote quantum computing system in response to receiving the query from the classical processing unit.

14. The processor-implemented method of claim 13, further comprising selecting the task for execution by the remote quantum computing system based at least in part on a latency associated with communicating with the remote quantum computing system, and a level of computation performed by the remote quantum computing system to complete the task.

15. The processor-implemented method of claim 13, in which the query from the classical processing unit comprises requesting beamforming weights and the task for execution by the remote quantum computing system comprises singular value decomposition.

16. The processor-implemented method of claim 13, further comprising encoding the query from the classical processing unit by preparing a superposition state of qubits, the superposition state comprising weights calculated by a quantum processing unit.

17. The processor-implemented method of claim 16, further comprising receiving from the remote quantum computing system at least one of Fourier transform results or linear system equation results based on the superposition state.

18. The processor-implemented method of claim 13, further comprising mapping a classical oracle to a quantum oracle by converting classical gates to reversible classical gates; converting the reversible classical gates to quantum gates; and erasing garbage gates using a controlled NOT (CNOT) gate.

19. The processor-implemented method of claim 13, further comprising selecting the remote quantum computing system from a plurality of remote quantum computing systems based at least in part on a fidelity and a number of qubits of the remote quantum computing system, and the query received from the classical processing unit.

20. The processor-implemented method of claim 13, further comprising:
processing any specific argument passing specifications for the selected remote quantum computing system, the specifications including application programming interfaces (APIs) exported by the remote quantum computing system for interface with the remote quantum computing system;
defining execution of processes on the remote quantum computing system; and
driving the execution of processes on the remote quantum computing system.

21. The processor-implemented method of claim 13, further comprising:
optimizing a cost function that is converted to a VQE (Variational Quantum Eigen-solver) optimization;
receiving an evaluation of the cost function from the remote quantum computing system;
executing a classical step of the VQE, including a gradient descent process based on the evaluation; and
iteratively repeating the executing the classical step and the receiving the evaluation until convergence to a solution of the VQE optimization.

22. A non-transitory computer-readable medium having program code recorded thereon, the program code executed by a processor and comprising:
program code to receive a query from a classical processing unit via a central processing unit (CPU) interface; and
program code to select a task for execution by a remote quantum computing system in response to receiving the query from the classical processing unit.

23. The non-transitory computer-readable medium of claim 22, in which the program code further comprises program code to select the task for execution by the remote quantum computing system based at least in part on a latency associated with communicating with the remote quantum computing system, and a level of computation performed by the remote quantum computing system to complete the task.

24. The non-transitory computer-readable medium of claim 22, in which the query from the classical processing unit comprises a request for beamforming weights and the task for execution by the remote quantum computing system comprises singular value decomposition.

25. The non-transitory computer-readable medium of claim 22, in which the program code further comprises program code to encode the query from the classical processing unit by preparing a superposition state of qubits, the superposition state comprising weights calculated by a quantum processing unit.

26. The non-transitory computer-readable medium of claim 25, in which the program code further comprises program code to receive from the remote quantum computing system at least one of Fourier transform results or linear system equation results based on the superposition state.

27. The non-transitory computer-readable medium of claim 22, in which the program code further comprises program code to map a classical oracle to a quantum oracle by converting classical gates to reversible classical gates; program code to convert the reversible classical gates to quantum gates; and program code to erase garbage gates using a controlled NOT (CNOT) gate.

28. The non-transitory computer-readable medium of claim 22, in which the program code further comprises program code to select the remote quantum computing system from a plurality of remote quantum computing systems based at least in part on a fidelity and a number of qubits of the remote quantum computing system, and the query received from the classical processing unit.

29. The non-transitory computer-readable medium of claim 22, in which the program code further comprises:
program code to process any specific argument passing specifications for the selected remote quantum computing system, the specifications including application programming interfaces (APIs) exported by the remote quantum computing system for interface with the remote quantum computing system;
program code to define execution of processes on the remote quantum computing system; and
program code to drive the execution of processes on the remote quantum computing system.

30. A quantum computing apparatus, comprising:
a classical processing unit; and
means for executing processes on a remote quantum computing system, the executing means coupled to the classical processing unit and to the remote quantum computing system.
